(19) United States
(12) Patent Application Publication
(10) Pub. No.: US 2017/0323261 A1
(43) Pub. Date: Nov. 9, 2017

(54) SYSTEMS AND METHODS FOR COLLECTING AND PROCESSING IMAGE DATA

(71) Applicant: Wal-Mart Stores, Inc., Bentonville, AR (US)

(72) Inventors: Nicholaus A. Jones, Fayetteville, AR (US); Aaron J. Vasgaard, Rogers, AR (US); Matthew A. Jones, Bentonville, AR (US)

(21) Appl. No.: 15/586,452

(22) Filed: May 4, 2017

Related U.S. Application Data
(60) Provisional application No. 62/332,307, filed on May 5, 2016.

(51) Int. Cl. G06Q 10/08; G06Q 30/02; G06K 9/62; G06F 17/30; B64C 39/02; B64D 47/08; H04N 7/18; G06K 9/00

(52) U.S. Cl. CPC G06Q 10/0833; H04N 7/185; G06Q 30/0269; G06K 9/6202; G06K 9/0063; B64C 39/024; G06F 17/30241; B64D 47/08; G06F 17/30277; B64C 2201/127; B64C 2201/146

(57) ABSTRACT

In some embodiments, apparatuses and methods are provided herein useful to collecting and processing image data relating to retail deliveries. In some embodiments, there is provided a system for capturing images of merchandise delivery containers, the system comprising: at least one unmanned aerial vehicle (UAV) having an optical sensor for capturing image sequences; a memory device for storing the captured image sequences; an image database including images of at least one of text, symbols, logos, graphic designs, and pictures from known merchandise delivery containers; and a control circuit configured to: receive the captured image sequences; compare the image sequences with the images from the image database; determine individual images in the image sequences that match the images from the image database to identify merchandise delivery containers; and determine, based on the image sequences, address information corresponding to the geographical locations of the identified merchandise delivery containers.

### CROSS-REFERENCE TO RELATED APPLICATION

This application claims the benefit of U.S. Provisional Application No. 62/332,307, filed May 5, 2016, which is incorporated herein by reference in its entirety.

### TECHNICAL FIELD

This invention relates generally to collecting and processing image data, and more particularly, to collecting and processing image data relating to retail deliveries.

### BACKGROUND

One important aspect in the retail setting is the delivery of merchandise to customers. Recently, it has become more and more common for customers to make merchandise purchases online from retailer websites and to have delivery made to the customer's location, such as by known delivery service providers. In addition, some customers visit shopping facilities and make purchases that are to be delivered to the customer's location. As a result, an ever increasing number of merchandise deliveries are being made to a customer's location. It is desirable to identify potential customers who have an interest in receiving merchandise deliveries.

There is existing image data from various sources of geographical areas and neighborhoods showing merchandise deliveries that have been made by delivery service providers. In addition, vehicles may be equipped with imaging devices that can capture images of merchandise deliveries made to desired geographical areas and neighborhoods. It would be desirable to use image data of these geographical areas and neighborhoods to identify completed merchandise deliveries, and thereby, to also identify potential customers who have an interest in receiving merchandise deliveries.

### BRIEF DESCRIPTION OF THE DRAWINGS

Disclosed herein are embodiments of systems, apparatuses and methods pertaining to collecting and processing image data relating to retail deliveries. This description includes drawings, wherein:

FIG. 1 is a flow diagram in accordance with some embodiments;

FIG. 2 is a block diagram in accordance with several embodiments; and

FIG. 3 is a block diagram in accordance with several embodiments

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to using image data to collect potential customer information. In one form, there is provided a data collection system comprising: a memory device configured to store image sequences captured by an image capture device at one or more geographic locations; an image database including a plurality of predetermined images of at least one of text, symbols, logos, graphic designs, and pictures from known merchandise delivery containers; and a control circuit in communication with the image database and configured to: compare the image sequences with the predetermined images from the image database; determine individual images in the image sequences that match the predetermined images from the image database to identify merchandise delivery containers; and determine, based on the identified merchandise delivery containers, address information corresponding to the geographical locations of the identified merchandise delivery containers.

In this form, the image sequences may include video captured by satellite or aerial imaging or from street panorama data capture software. Further, the plurality of predetermined images of at least one of text, symbols, logos, graphic designs, and pictures from known merchandise delivery containers may be identifying characteristics that distinguish them as containing merchandise from predetermined retail entities. In addition, the control circuit may be configured to use pattern recognition software with pixel matching to match the individual images in the image sequences with the predetermined images from the image database to identify merchandise delivery containers.

Also, in this form, the system may further include an optical device mounted on a vehicle and configured to create the image sequences. The vehicle may include one or more of automobiles, delivery vehicles, aerial vehicles, and drones.

Moreover, in this form, the system may further include a geographic or demographic database in communication with the control circuit, the database containing predetermined geographic or demographic data for determining the one or more geographic locations from which the image sequences are captured. In addition, the control circuit may be configured to update a marketing database with identification information corresponding to the address information, the marketing database configured to facilitate targeted marketing and advertising communications. Further, the control circuit may be configured to determine one or more of the type of merchandise delivered, the frequency of merchandise deliveries, and the source of the merchandise deliveries to the addresses identified by the control circuit. Also, the control circuit may be configured to perform one or more of market share analysis, mapping digital customer saturation and location, identifying locations to send individuals for customer service, and identifying geographic areas where sales may be increased.

In one form, there is provided a method for collecting data comprising: storing a plurality of predetermined images of at least one of text, symbols, logos, graphic designs, and pictures from known merchandise delivery containers in an image database; storing image sequences captured by an image capture device at one or more geographic locations; comparing the image sequences with the predetermined images from the image database; determining individual images in the image sequences that match the predetermined images from the image database to identify merchandise delivery containers; and determining, based on the identified merchandise delivery containers, address information corresponding to the geographical locations of the identified merchandise delivery containers.

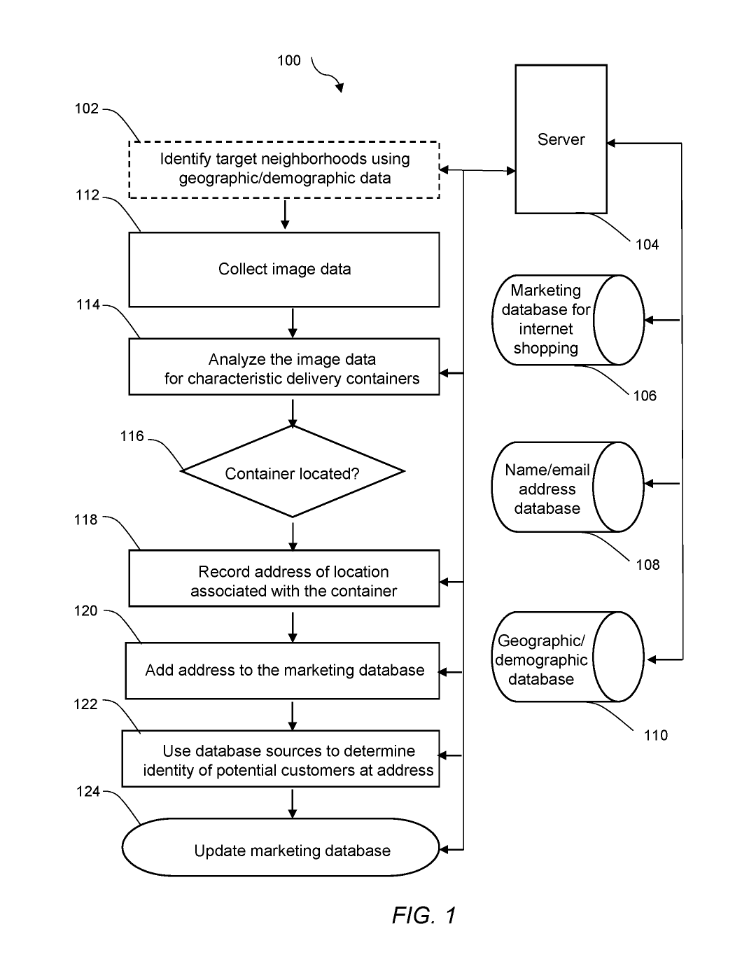

Referring to FIG. 1, there is shown a flow diagram for a process 100 of collecting and processing image data relating to retail deliveries. It is generally contemplated that certain geographic neighborhoods and locations are of interest. The process generally involves collecting image data from these geographic neighborhoods and areas and analyzing this image data for retail delivery containers/boxes. The addresses corresponding to the locations of the retail delivery containers/boxes can then be added to a marketing database, such as for customers engaged in internet shopping. As should be understood, some of the steps in the flow diagram are optional and are not required in some processes, and some of the steps may be performed in different sequences in some processes.

At block 102, a user may identify neighborhoods of interest using geographic and/or demographic data. In one form, it is contemplated that the user may be a retailer seeking to improve its customer marketing database of online purchasers. The user may want to focus on specific geographic neighborhoods where the user does not yet have many on-line purchases (shopping over the internet). In other words, it may be desirable to focus on a neighborhood where geographic data shows that there are relatively few internet shoppers. As another example, the user may want to focus on neighborhoods that have a lower average age because it is believe that this lower average age correlates to a higher probability of internet shoppers. In other words, it may be desirable to focus on a neighborhood where demographic data indicates there is a relatively high concentration of younger people.

To facilitate identifying target neighborhoods using geographic and/or demographic data, it is contemplated that the user may access a database providing such information. As can be seen at block 104, the process 100 contemplates the use of a server or similar computing system, which is, in turn, coupled to and has access to one or more databases. The term server is well-known in the art and generally includes a computer system that provides access to databases and that may share data and resources with numerous devices. Server architecture and functionality is well-known in the art, and the process 100 may use any of the various known architectures or types.

As shown in FIG. 1, the server may have access to several different databases, such as a marketing database 106, a name/email address database 108, and a geographic/demographic database 110. Although the databases have been arranged in this manner as three separate databases for ease of understanding, it should be evident that many different arrangements are possible. The information may all be contained in what may be deemed to be one comprehensive database, or the information may be separated into additional databases. Further, as should be evident, the one or more databases may include overlapping information.

In one form, the geographic/demographic database 110 may include geographic and/or demographic information associated with various neighborhoods. For example, if the user is a retailer, the geographic/demographic database 110 may include the geographic and/or demographic information of shoppers who have made past online purchases from the retailer. This information may be analyzed to determine if there appear to be gaps in the database. In other words, this information may be evaluated to determine if there are neighborhoods where relatively few online purchases have been made in the past and where it may be desirable to collect image data to determine if there are, in fact, a significant number of internet shoppers in those neighborhoods. Alternatively, the user may access other types of general databases to identify a neighborhood or area of interest, such as databases indicating a relatively young average age in a neighborhood or indicating a high concentration of internet purchases from multiple retailers. It should be evident that this identification step 102 is optional and that a user may use a less systematic, less data driven approach to determining neighborhoods of interest.

At block 112, image data is collected showing image sequences of the neighborhood(s), and particularly areas where retail deliveries are made. In other words, the image sequences should show areas in the neighborhood(s) where retail delivery containers will be deposited in response to online orders placed by internet shoppers. It is generally contemplated that the user may either use third party sources for the image data and/or may generate some or all of the image data itself. For example, the third party sources may provide image sequences in the form of video captured by satellite or aerial imaging or from street panorama data capture software. Of course, the satellite or aerial imagery must be of sufficient resolution to allow identification of the retail delivery containers. Also, there are a number of third party sources that provide street imagery of the areas in front of residences, including around and about entry ways and mailboxes, where retailer delivery containers are likely to be deposited.

In another form, it is contemplated that some or all of the image sequences may be captured by the user itself. For example, the user may utilize vehicles (e.g., delivery trucks or other delivery vehicles, airplanes, aerial drones, automobiles, etc.) including optical devices (such as cameras) that can create and capture video and/or images of neighborhoods. If the user is a retailer with a delivery service, it may use its own delivery trucks with mounted cameras to accumulate this data. Alternatively, if the retailer works with an independent delivery service to make deliveries, it might commission this delivery service to generate this image data. Again, there must be sufficient resolution to allow automatic comparison of images and to see the identifying marks on a delivery container. Regardless of the source, it is contemplated that the collected image sequences captured by an image capture device at one or more geographic locations will be stored on any of various suitable memory or data storage devices, which are well known in the art.

At block 114, the memory device with the collected image sequences is analyzed. More specifically, it is contemplated that a control circuit compares the image sequences on the memory device with known images of retail delivery containers (or characteristic delivery containers) from an image database. In one form, the video and/or images are processed using image recognition analysis to detect characteristic delivery containers (e.g., delivery boxes with specific characteristics that identify them as including products from particular retail entities) that have been delivered to a location. Any of various types of image recognition analysis may be applied, and in one form, it is contemplated that the analysis is performed by pixel matching the collected image sequences with the image database. In other words, the control circuit may be configured to use pattern recognition software with pixel matching to match the individual images in the image sequences with images from the image database to identify merchandise delivery containers. It is generally contemplated that the user creates the image database to store, for comparison purposes, images of text, symbols, logos, graphic designs, pictures, etc. (including portions thereof), from known merchandise delivery containers of known retailers. In other words, the images of text, symbols, logos, graphic designs, and pictures from known merchandise delivery containers are identifying characteristics that distinguish them as containing merchandise from certain known retail entities.

At block 116, there is a match, indicating that a known delivery container has been located in the image sequences. In other words, the control circuit determines that individual images in the image sequences match images from the image database to identify merchandise delivery containers. The process 100 then proceeds to the next steps. Otherwise, if there is no match, the control circuit is configured to simply continue with the analysis of the image sequences and continue to look for images that match known delivery containers.

At block 118, the address of the location associated with the delivery container is identified and recorded. In other words, the control circuit determines, based on the identified merchandise delivery containers, address information corresponding to the geographical locations of the identified merchandise delivery containers. So, for example, one or more images in the image sequences may show a delivery container located in front of a residence. Other images may also show the address of that location. Alternatively, it may be possible to determine the address based on the location of the residence relative to identified streets in the image sequences. This address corresponds to a delivery address for an online purchase and may indicate a frequent internet shopper. In other words, the process has detected a potential customer location that is likely to receive future delivery purchases. At block 120, the address may be added to the marketing database 106.

At block 122, database sources may be used to determine the identity of potential customers at the identified address. For instance, there are numerous available public look-up databases that allow determination of the homeowner of record, given identification of the address of the residence. These databases indicate an individual who has received an online purchase and who may be a frequent internet shopper. In addition, the user's private databases may be consulted, such as name/email address database 108, to see if identification information corresponding to the address is already in the user's database 108.

The location/address information may be acquired in several different ways and may be utilized in various ways. Regarding acquisition, the location/address information may be acquired directly from the data source itself, such as from the image sequences. For example, delivery vehicles equipped with cameras may be used to capture the images and may be instructed generally to collect address information. Both the delivery container and address may be captured in the image sequences. Alternatively, the delivery vehicles may capture the image, note the address separately, and then transmit both the image and the address to database(s). Also, regarding utilizing the address information, this information may be used for targeted advertising. In other words, advertisements can be sent out to addresses captured in the image sequences or otherwise collected.

At block 124, the user's databases may be updated, such as, for example, the marketing database for internet shopping 106. If the potential customer identification information is not already in the database 106, this identification information may be added. The marketing database 106 may be configured to facilitate targeted marketing and advertising communications, such as, for example, mentioned above. Alternatively, if the potential customer identification information is already in one or more databases, these databases may be updated to make use of this delivery information. More specifically, databases may be updated to include information regarding the frequency and type of online purchases and the identity and types of retailers from whom purchases have been made.

When characteristic boxes are detected, the location (e.g., residence, office, building, etc.) can be labeled as a potential or current digital customer for targeted advertising and market share analysis. Databases can be maintained and/or accessed to identify potential customer identities and contact information. The collection of these target locations and/or customers can further be considered with respect to market share analysis, mapping digital customer saturation and location, where to send workers for customer service, identifying areas where sales may be increased, and potentially lowering delivery costs. The ability to detect customer locations can improve efficiencies of replenishing that location and where to place products and where to send individuals for customer service increasing sales and lowering costs.

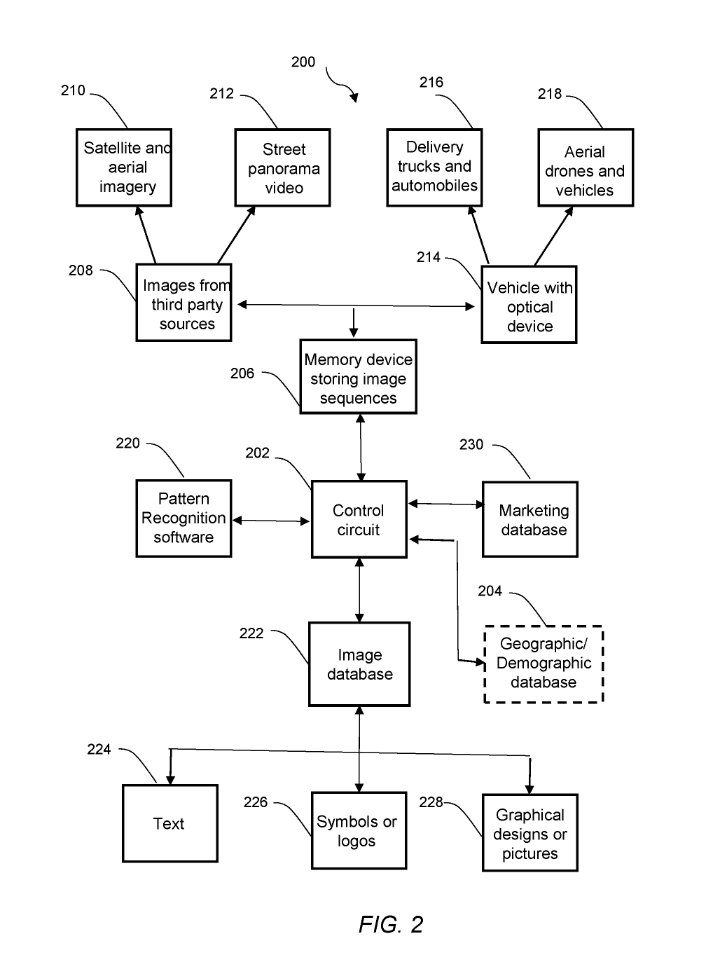

Referring to FIG. 2, there is shown a block diagram illustrating components of a system 200. The system 200 includes a control circuit that may access a geographic and/or demographic database to determine geographic areas of interest. The control circuit compares and matches image sequences stored on a memory device to an image database of distinctive aspects of merchandise delivery containers. When there is a match, the control circuit may update a marketing database of potential internet shoppers with identification information corresponding to the location of delivery containers. As should be understood, some of the components shown in the block diagram are optional and are not required in some forms.

The system 200 includes a control circuit 202 that is operatively coupled to and/or in communication with other components in the system 200. The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 202 may be configured (for example, by using corresponding programming stored in a memory as will be well understood by those skilled in the art) to carry out one or more of the steps, actions, and/or functions described herein. The control circuit 202 may also be in wireless communication with a central computing device, or server, which may enable access to and communication with various databases.

In one form, the control circuit 202 may access a geographic and/or demographic database 204 to determine geographic areas and neighborhoods of interest. For example, it may be determined that certain internet shoppers in specific geographic areas and neighborhoods appear to be underrepresented in the database 204, and therefore, it would be desirable to locate potential interest shoppers in these geographic neighborhoods. As an additional example, it may be determined that certain geographic areas and neighborhoods have a large youthful demographic, and therefore, it might be desirable to focus on these geographic areas and neighborhoods. As should be evident, any of a number of geographic and demographic characteristics may be considered in deciding what areas and neighborhoods may be of interest. Further, it should be understood that this data driven approach is optional and that instead other factors and considerations may determine areas and neighborhoods that may be of interest.

The control circuit 202 accesses image sequences stored on a memory device 206. These image sequences may be collected in a number of ways. More specifically, it is contemplated that image sequences may be collected from third party sources and/or may be collected directly by the user's action. In other words, some or all of the image sequences may be generated and captured by third party action, and some or all of the image sequences may be generated and capture by the user's own actions.

In one form, the images may be collected, in whole or in part, from third party sources 208. For example, it is contemplated that some or all of the image sequences may be from existing satellite and/or aerial imagery 210. Of course, it is understood that this imagery must be of sufficient resolution to allow recognition of identifying characteristics on merchandise delivery containers. Alternatively, it is contemplated that some or all of the image sequences may be in the form of street panorama video 212 generated by street panorama data capture software. As should be evident, many other third party sources may also be available and may generally include many forms of online postings available to the public.

In another form, some or all of the image sequences may be collected directly by the user's own action in capturing the image sequences. In this form, some or all of the image sequences may be captured by any of various types of vehicles equipped with optical devices 214 that are navigating in or near geographic areas and neighborhoods of interest (the optical devices may be mounted thereon in some fashion). For example, the user may be a retailer that is engaged in making merchandise deliveries, and in one form, the user may equip its delivery vehicles 216 (such as delivery trucks and automobiles), or the delivery vehicles 216 of independent service provides who are responsible for delivering the user's merchandise, with cameras and other optical devices that capture image sequences. As another example, the user may equip aerial drones or vehicles 218 with such cameras or other optical devices to capture the desired images of geographic areas and neighborhoods. Again, of course, the vehicles and optical devices must be sufficient to provide imagery of sufficient resolution for comparison purposes, as described further below.

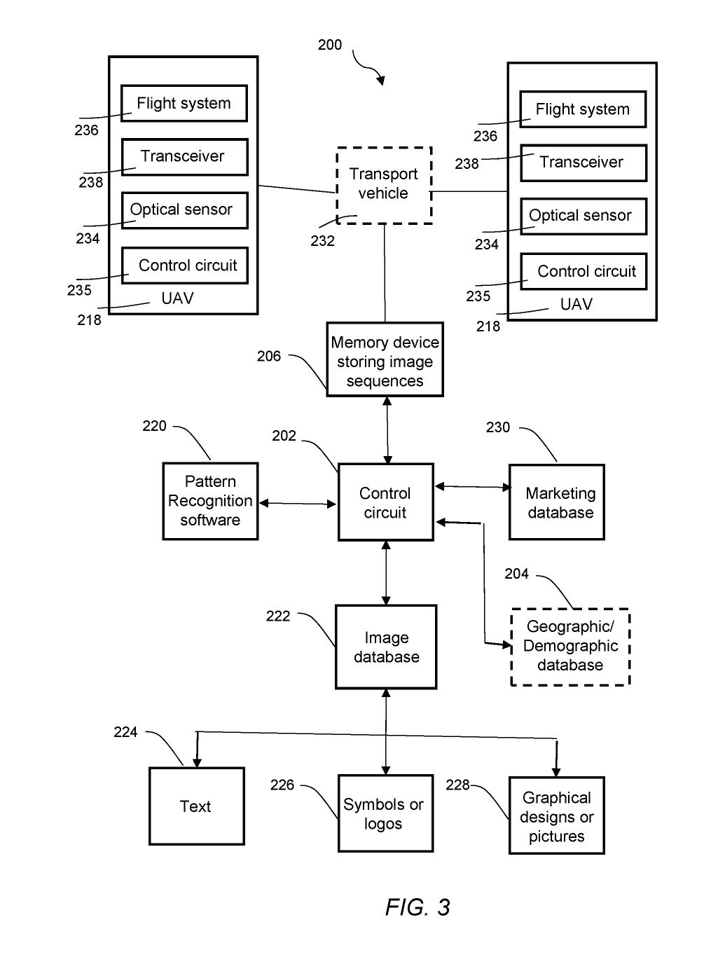

More particularly, in one form, it is contemplated that the system 200 (FIG. 3) may employ one or more aerial drones or unmanned aerial vehicles (UAVs) 218. In this form, the control circuit 202 may access the geographic and/or demographic database 204 to determine geographic areas or neighborhoods of interest, such as areas where a retailer makes few deliveries relative to other areas. Once a target geographic area is determined, a transport vehicle 232 may transport a group of UAVs 218 to this general vicinity and allow them to fly over and survey the area. Each UAV 218 will include an optical device 234, i.e., camera, that can be used to capture image sequences, i.e., still images or video. In this manner, the target area may be saturated with a desired number of UAVs 218 so as to improve the likelihood of capturing images of merchandise delivery containers. In addition, it may be determined that certain days and certain times of day are more likely to yield usable images, such as when deliveries are most likely to occur.

It is generally contemplated that the UAV(s) 218 include certain conventional components operated by a UAV control circuit 235 that allow them to perform their mission. For example, each UAV 218 includes a motorized flight system 236 configured to facilitate flight of the UAV 218. In one form, it is generally contemplated that this motorized flight system 236 includes props, a navigational guidance system coupled to the props, a power source to enable operation of the props and navigational guidance system, and landing gear. Each UAV 218 also includes a transceiver 238 configured for wireless communication, such as for communication with the transport vehicle 232 and/or with a command and control center.

Further, as mentioned, the UAV 218 includes an optical (or imaging) sensor 234 configured to capture a plurality of images. The optical sensor 234 may be any of various types of cameras, video devices, etc., that may be configured to capture still images and/or video. In this form, it is contemplated that each UAV 218 may fly autonomously according to a programmed flight plan. It is further contemplated that the captured images may be transmitted to the transport vehicle 232 or the command and control center, and, depending on the content of the images, a pilot or operator may take control of a UAV 218 to navigate it in certain circumstances.

More specifically, it is contemplated that the UAVs 218 will be in wireless communication with the transport vehicle 232 and/or with the remote command and control center. The UAVs 218 may transmit the images to the transport vehicle 232 and/or remote command and control center. If desired, these transmitted images may be analyzed at that time (as described further below) for merchandise delivery containers. If images of a merchandise delivery container are observed, a human pilot may take over control of the UAV 218 to capture sufficient information regarding the specific location of that container.

From whatever source, the image sequences are stored in one or more memory devices 206. The control circuit 202 then examines and evaluates the image sequences utilizing and of various types of image analysis using conventional pattern recognition software 220. In one form, it is contemplated that the pattern recognition software 220 uses pixel matching to compare individual images in the image sequences with individual images from an image database 222 to determine if there is a match. A match indicates that a retail delivery container has been identified.

The image database 222 may include various types of identifying characteristics of known merchandise delivery containers. These identifying characteristics may be text 224, symbols or logos 226, and/or graphic designs or pictures 228 (and/or portions thereof) from known merchandise delivery containers of various retailers. Preferably, the image database 222 includes some combination of all of these identifying characteristics so as to improve the likelihood that a correct match is made and to increase the number of delivery containers that are identified.

Once a delivery container is identified, the control circuit 202 may be configured to seek information regarding the address of the location corresponding to the delivery container. This address information may be determined in any of various ways. For example, the control circuit 202 may be configured to analyze images on the image sequences near the identified image of the delivery container to find an address. Alternatively, an individual may use the control circuit 202 to manually analyze the images on the image sequences near the identified image for indications of the address, such as the actual address number or the relative location of a residence along a street.

Once an address is identified, the control circuit 202 may be configured to seek potential customer identification information corresponding to the delivery address. Again, this identification information may be determined in various ways. For instance, the control circuit 202 may access private and public databases to determine this information.

Once the control circuit 202 determines identification information, it may update a marketing database 230 with this information. For example, the marketing database 230 may be a database interne shoppers or online purchasers. The control circuit 202 may be configured to update the marketing database 230 with identification information corresponding to the address information so as to facilitate targeted marketing and advertising communications. Further, the control circuit 202 may update the marketing database 230 or other databases with information relating to the identified delivery. The control circuit 202 may be configured to track and record the type of merchandise delivered, the frequency of merchandise deliveries to an address, and/or the source of the merchandise deliveries. The control circuit 202 may also be configured to perform any of various additional data analyses. For example, the control circuit 202 may be configured to perform market share analysis, mapping digital customer saturation and location, identifying locations to send individuals for customer service, and/or identifying geographic areas where sales may be increased.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for capturing images of merchandise delivery containers, the system comprising:
at least one unmanned aerial vehicle (UAV) comprising:
a motorized flight system configured to facilitate flight of the UAV;
a transceiver configured for wireless communication;
an optical sensor configured to capture image sequences;
a first control circuit operatively coupled to the motorized flight system, the transceiver, and the optical sensor, the first control circuit configured to operate and fly the UAV;
a memory device configured to store image sequences captured by the at least one UAV at one or more geographic locations;
an image database including a plurality of predetermined images of at least one of text, symbols, logos, graphic designs, and pictures from known merchandise delivery containers;
a second control circuit in wireless communication with the at least one UAV and operatively coupled to the memory device and image database, the second control circuit configured to:
receive the image sequences captured by the at least one UAV;
compare the image sequences with the predetermined images from the image database;
determine individual images in the image sequences that match the predetermined images from the image database to identify merchandise delivery containers; and
determine, based on the image sequences, address information corresponding to the geographical locations of the identified merchandise delivery containers.

2. The system of claim 1, wherein the at least one UAV is a plurality of UAVs configured to fly over and capture image sequences of a predetermined geographic neighborhood.

3. The system of claim 2, further comprising a transport vehicle configured to transport the plurality of UAVs to the predetermined geographic neighborhood.

4. The system of claim 1, wherein the second control circuit is physically located at a command and control center remote from the at least one UAV, the second control circuit in wireless communication with the at least one UAV.

5. The system of claim 1, wherein the plurality of predetermined images of at least one of text, symbols, logos, graphic designs, and pictures from known merchandise delivery containers are identifying characteristics that distinguish them as containing merchandise from predetermined retail entities.

6. The system of claim 1, wherein the second control circuit is configured to use pattern recognition software with pixel matching to match the individual images in the image sequences with the predetermined images from the image database to identify merchandise delivery containers.

7. The system of claim 1, further comprising a geographic or demographic database in communication with the second control circuit, the database containing predetermined geographic or demographic data for determining the one or more geographic locations from which the image sequences are captured.

8. The system of claim 1, wherein the second control circuit is configured to update a marketing database with identification information corresponding to the address information, the marketing database configured to facilitate targeted marketing and advertising communications.

9. The system of claim 1, wherein the second control circuit is configured to determine one or more of the type of merchandise delivered, the frequency of merchandise deliveries, and the source of the merchandise deliveries to the addresses identified by the second control circuit.

10. The system of claim 1, wherein the second control circuit is configured to perform one or more of market share analysis, mapping digital customer saturation and location, identifying locations to send individuals for customer service, and identifying geographic areas where sales may be increased.

11. A method for capturing images of merchandise delivery containers, the method comprising:
providing at least one unmanned aerial vehicle (UAV) comprising:
a motorized flight system configured to facilitate flight of the UAV;
a transceiver configured for wireless communication;
an optical sensor configured to capture image sequences;
a first control circuit operatively coupled to the motorized flight system, the transceiver, and the optical sensor, the first control circuit configured to operate and fly the UAV;
storing a plurality of predetermined images of at least one of text, symbols, logos, graphic designs, and pictures from known merchandise delivery containers in an image database;
storing image sequences captured by the at least one UAV at one or more geographic locations;
receiving the image sequences captured by the at least one UAV;
comparing the image sequences with the predetermined images from the image database;
determining individual images in the image sequences that match the predetermined images from the image database to identify merchandise delivery containers; and
determining, based on the image sequences, address information corresponding to the geographical locations of the identified merchandise delivery containers.

12. The method of claim 11, wherein the at least one UAV is a plurality of UAVs configured to fly over and capture image sequences of a predetermined geographic neighborhood.

13. The method of claim 12, further comprising transporting the plurality of UAVs to the predetermined geographic neighborhood.

14. The method of claim 11, further comprising providing a command and control center remote from the at least one UAV and in wireless communication with the at least one UAV.

15. The method of claim 11, wherein the plurality of predetermined images of at least one of text, symbols, logos, graphic designs, and pictures thereof from known merchandise delivery containers are identifying characteristics that distinguish them as containing merchandise from predetermined retail entities.

16. The method of claim 11, wherein the determining individual images in the image sequences that match comprises using pattern recognition software with pixel matching to match the individual images in the image sequences with the predetermined images from the image database to identify merchandise delivery containers.

17. The method of claim 11, further comprising determining the one or more geographic locations from which the image sequences are captured based on a geographic or demographic database.

18. The method of claim 11, further comprising updating a marketing database with identification information corresponding to the address information, the marketing database configured to facilitate targeted marketing and advertising communications.

19. The method of claim 11, further comprising determining one or more of the type of merchandise delivered, the frequency of merchandise deliveries, and the source of the merchandise deliveries to addresses identified from the address information.

20. The method of claim 11, further comprising performing one or more of market share analysis, mapping digital customer saturation and location, identifying locations to send individuals for customer service, and identifying geographic areas where sales may be increased.
